(19) United States
(12) Patent Application Publication
(10) Pub. No.: US 2015/0165728 A1
(43) Pub. Date: Jun. 18, 2015

(54) VEHICLE ROOF

(71) Applicant: AGC GLASS EUROPE, Louvain-La-Neuve (BE)

(72) Inventors: Denis Legrand, Wargnies Le Grand (FR); Michel Meyers, La Hulpe (BE)

(73) Assignee: AGC GLASS EUROPE, Louvain-La-Neuve (BE)

(21) Appl. No.: 14/409,197

(22) PCT Filed: Jun. 12, 2013
(86) PCT No.: PCT/EP2013/062116

§ 371 Date: Dec. 18, 2014

(30) Foreign Application Priority Data
Jun. 19, 2012 (BE) BE 2012/0412

(51) Int. Cl. B32B 17/10; B62D 25/06; B60J 1/00

(52) U.S. Cl. CPC B32B 17/10036; B60J 1/001; B62D 25/06; B32B 17/10229; B32B 17/10211; B32B 17/10532; B32B 17/10761; B32B 17/10779; B32B 2605/00

(57) ABSTRACT

The invention relates to a laminated glass sunroof, having variable light transmission and providing improved comfort in terms of temperature, including two glass sheets, i.e. an outer and inner glass sheet, which are joined together by means of intermediate thermoplastic sheets, a suspended particle device (SPD) film assembly for controlling the light transmission, which is incorporated into the laminate between the two glass sheets, and a system of low-emissivity layers arranged at position 4.

The invention relates to vehicle roofs formed, at least in part, from a glazing unit. More precisely, the invention relates to roofs the glazing unit of which covers a large portion of their area or even all of the latter.

Glazed roofs are increasingly being substituted for traditional roofs that are part of the body of vehicles. The choice of these roofs is a result of manufacturers offering to their customers this option, which makes the vehicle seem like it opens onto the exterior, like a convertible, without the drawbacks of convertibles, these roofs maintaining the comfort levels of traditional sedans. To do so glazed roofs must meet many requirements. It is recommended to meet safety requirements first. Glazed roofs must meet regulations that establish an ejection resistance in the case of an accident. Specifically, they must meet the rules known as “R43” rules. Passenger ejection resistance especially necessitates the use of laminated glazing units.

The presence of laminated glazing units does not obviate the need to limit weight. For this reason, the thickness of the laminated roofs used must also be kept down. In practice, the glazing units of these roofs are no larger than 8 mm and preferably no larger than 7.5 mm in thickness.

The aim of choosing glazed roofs, as mentioned above, is to increase the brightness of the passenger compartment. This increase in brightness must not be obtained at the expense of other properties that ensure passenger comfort and in particular passenger thermal comfort. The presence of glazed roofs, motivated by this brightness increase, also increases heat exchange with the exterior. This is observed via the greenhouse-effect mechanism when the vehicle is exposed to intense solar radiation. However, the roof must also contribute to maintaining the temperature of the passenger compartment when it is cold.

Various measures are employed to control thermal conditions, including the use of high-selectivity glazing units. These conditions result from the choice of the glass used (most often mineral glass, but also possibly organic glass). Additional filters borne by these glazing units, especially filters consisting of systems of layers selectively reflecting the infrared, also have a bearing on these conditions. Solutions addressing these requirements are known from the prior art. This is the case in particular of patent EP 1 200 256.

The choice of glazed roofs has also allowed additional functionalities to be developed, for example integration of photovoltaic systems that contribute to the electrical production required to operate various vehicle systems. The implementation of such systems is the subject of many publications, and especially patent EP 1 171 294.

Moreover, it may only be desired to increase passenger-compartment brightness from time to time. The user may, depending on the moment of use, prefer a lower brightness, or simply want to maintain an aspect of “privacy” that prevents the passenger compartment from being looked into from the exterior.

Solutions allowing the light transmission of a glazing unit to be modified to suit the conditions of use have already been developed. It may be a question in particular of what are referred to as “electrically controlled” glazing units, such as glazing units comprising electrochromic means in which the variation is obtained by modifying the state of colored ions in compositions contained in these glazing units. It may also be a question of glazing units comprising layers of particles in suspension, which, contingent on the application of an electrical voltage, are ordered or not, such as the systems called SPDs (for suspended particle devices).

The development of glazed roofs raises other questions and opens the way to novel products. Certain functions may or must be modified on account of the specificities of these roofs. One aim of the invention is to make the use of glazed roofs having the functionalities indicated above more up to the task of meeting the wishes of manufacturers in terms of their performance and their ease of use.

Although the light transmission of glazed roofs is systematically low, on the one hand in order to provide what may be qualified an aspect of “privacy”, and on the other hand to limit the energy transfer that is indissociable from wavelengths in the visible domain, in almost all of such roofs these transmissions are controlled by the choice of the sheets of glass and interlayers and of layers imparting specific properties.

Thus, conventionally, the light transmission of glazed roofs is lower than 50% and often much lower, for example being about 15 to 20% or less of the incident light (measured according to EN 410).

The use of control means allowing light transmission to be varied is also often combined with these conventional means, namely absorbent glass sheets and layers that modify properties. These conventional means may help control the opto-energetic properties of the roof, but also optionally adjust its color in reflection or transmission.

Roofs the light transmission of which is modified by way of an SPD are particularly advantageous especially because of their very rapid response to control signals. The variation in the light transmission obtained with these SPDs between the two “clear” and “dark” states depends on the systems chosen. In conventional products of this type, the variation in transmission between these two states may reach 40% or more, with, in the dark state, a transmission that may be extremely low. Moreover, the presence of these systems also leads to a very low energy transmission, independently of whether they are in their clear or dark state. This decrease in energy transmission is especially related to the measures taken to prevent the functional elements of these systems, i.e. the orientable particles, from being subjected to too great a temperature increase.

The use of a functional SPD film is the subject of prior-art publications and especially WO 2005/102688, which specifies certain operating conditions.

The SPD films and electrical control conditions chosen also allow, if needs be, the magnitude of the variation in light transmission to be set. In roof applications, according to the invention, the dark state advantageously has a transmission that is as low as possible, especially lower than 3%, preferably lower than 2% and in a particularly preferred way lower than 1%. Such a transmission may be obtained with commercially available SPD films, even when the film is very small in thickness. To meet the wishes of manufacturers, in contrast the transmission in the clear state is preferably significant, but, as for glazed roofs without an SPD film, it is preferably lower than 50%, and even lower than 40% and most often lower than 30%.

The shifts between clear and dark state may result only from the effect of operation of the SPD films, the presence of glass sheets and colored interlayers optionally supplementing the means for controlling light transmission. If needs be these effects in combination allow the transmission in the clear state to be decreased, for example to less than 15%. However, as indicated above, one role of the sheets of glass and interlayers is also to set the color in transmission and reflection.

Although the variation in light transmission is a key factor in the choice of the SPD films, the latter also play an important role in the energy transmission of the glazing units in which they are incorporated. In the dark state, the energy transmission, independently of the presence of absorbent glass sheets or interlayers, is ordinarily lower than 10% and advantageously lower than 5%. The dark state is normally, but not exclusively, that of the vehicle when it is parked, a very low energy transmission is therefore particularly welcome. In the clear state the energy transmission is substantially greater, because the visible radiation also transmits energy. Nevertheless, the SPD film absorbs a significant share of the energy. Advantageously the elements composing the glazing unit, SPD film, glass sheets and layers reflecting the infrared are chosen so that the solar energy transmission is as low as possible. The solar energy transmission of the SPD film alone is lower than 30% and preferably lower than 25%. The solar energy transmission of the complete glazing unit is advantageously lower than 20% and preferably lower than 15%.

Roofs according to the invention that meet the conditions indicated above, must also meet requirements relating to the magnitude of the reflection therefrom, and to their color in reflection and transmission.

These roofs must, not only for aesthetic reasons but also for reasons of safety, not have an excessive reflection in the visible domain, irrespectively of whether they are in the clear or dark state. It is preferably lower than 20%, advantageously lower than 15% and in a particularly preferred way lower than 10%.

Manufacturers, for aesthetic reasons this time, also require the reflection to be relatively neutral, in other words they require the observed color of the roofs not to be too accentuated. In particular purple tints must be avoided. Bluish nuances may blend with the commonest vehicular tints.

The CIE Lab color coordinates (illuminant D65 at 10°) of the color in reflection, both in the dark state and in the clear state, are preferably between the following limits:

−8<a*<3 and preferably −7<a*<2

−7<b*<3 and preferably −2<b*<1.

The color in transmission must also be controlled, essentially in the clear state. In the dark state, since the transmission is very low, the color is much less appreciable. The transmission in the clear state is preferably:

−10<a*<0 and preferably −8<a*<0

−2<b*<14 and preferably −0<b*<10.

The use of SPD films is subject to a few requirements other than those relating to their ability to modify light transmission. Firstly, it is recommended to protect the functional film mechanically and chemically but also thermically.

In SPD films, the orientable particles, which are incorporated into a polymer matrix, may be degraded by an excessive increase in temperature. To a lesser extent, the films may see their properties irreversibly modified if they are exposed to temperatures that are too low, −40° C. for example. Exposure to external temperature variations is accentuated by the position envisioned according to the invention. Solar radiation, and in particular infrared rays, may lead to a large increase in the temperature of the roof.

To prevent degradation of the film, provision is made, especially in the aforementioned text, for an infrared filter to protect the SPD film.

It is also desirable to protect the SPD from the ultraviolet. The materials used to form the laminates and encapsulate the cells are ordinarily products that by themselves are UV screens. This is in particular the case for materials such as polyvinyl butyrals (PVB) or polymers of ethylene vinyl acetate (EVA), described previously for producing the laminated structures of these roofs. The presence of such compounds forms a practically complete UV filter. Therefore, it is not necessary to provide additional elements.

The film used to control light transmission must be supplied with electrical power. It is necessarily connected to the general electrical power supply of the vehicle via the edges of the glazing unit. The connecting electrical cables are not normally transparent. In order not to interrupt the even limited transparency of the glazing unit, care is taken to conceal these cables in peripheral zones of the glazing unit, which normally comprise opaque enamel portions especially intended to mask the marks of irregular adhesive joints.

The presence of a glazed roof modifies the conditions of thermal comfort experienced by occupants of the vehicle. Although heating when the vehicle is exposed to the sun calls for the conditions described above in order to decrease the energy transmission as much as possible, the presence of glazed roofs may also lead to passengers experiencing a sensation qualified “cold shoulder”, this sensation being caused by heat loss from the passenger compartment when the exterior temperature is lower than a comfortable room temperature.

In practice, to restore passenger comfort levels, manufacturers essentially use a screen that allows the interior surface of the glazing unit to be covered in its entirety. A screen and the elements that are associated therewith, especially those used to motorize its deployment, are costly and increase the weight of the vehicle.

In order to make it possible not to have to use a screen, the invention provides roofs through which heat loss is minimized. In order to achieve this result, the invention proposes to apply low-E layers (low-emissivity layer) to that face of the glazing unit which is turned toward the passenger compartment. In keeping with the conventional nomenclature used to designate the faces of laminated glazing units, it is a question of position 4. The faces are numbered starting from the face exposed to the external atmosphere. The layers in question act as a filter that selectively reflects the infrared rays emitted by the passenger compartment, without forming a substantial obstacle to the transmission of rays in the visible domain from the exterior to the interior.

It is chosen to place the thin layers in position 4 despite the fact that in this position the layers are not protected from degradation, especially mechanical degradation. It is possible to choose low-E layers that are mechanically and chemically resistant enough.

Advantageously, on account of how important it is to obtain coatings with a good mechanical resistance, what are called “hard” layers, such as those produced by PECVD, CVD or pyrolytic techniques, will be chosen. However, low-E systems may also be produced using vacuum cathode sputtering techniques, provided that the systems obtained are composed of layers that are sufficiently resistant.

According to the invention, it is preferred to use a system of low-emissivity layers the emissivity of which is lower than 0.3 and preferably lower than 0.2 and in a particularly preferred way lower than 0.1.

The most commonplace pyrolytic low-E (low-emissivity) systems comprise a layer of doped tin oxide deposited on a first layer having the role of neutralizing color in reflection. The layer making contact with the glass is ordinarily a layer of silica or silicon oxycarbide, optionally modified by additives. Tin oxide layers, compared to the layers of systems deposited by cathode sputtering, are relatively thick, i.e. more than 200 nm and in certain cases more than 450 nm in thickness. These thick layers are sufficiently resistant to withstand exposure to mechanical and/or chemical attack.

All the constituent elements of roofs according to the invention participate, to varying degrees, to achieve the desired properties. In particular, the glass sheets and the interlayer sheets may modulate the transmission and reflection of light and energy.

The glass sheets used to form the laminated glazing unit may have the same composition and possibly the same thickness, which may make them easier to shape beforehand, the two sheets being bent simultaneously for example. Most often the glass sheets have different compositions and/or thicknesses, and in this case they are preferably shaped separately.

The glass sheets are preferably chosen so that the transmitted light, just like the reflected light, is of as neutral as possible a color. Overall, the glazing unit has a gray or slightly bluish color.

The possible presence of colored interlayers participates in the absorption of light. Their use may be envisioned as a partial substitute at least to the contribution of the glass sheets to establishing a particular color. This situation may arise, for example, when, in order to integrate photovoltaic elements into the glazing unit, at least the external glass sheet is a sheet of poorly absorbent glass or even extra-clear glass. Excepting this case, most often the external sheet is also a sheet of absorbent glass, and there is no need for a colored interlayer.

The glass sheet turned toward the passenger compartment may also, exceptionally, be made of clear glass. It is most often absorbent and contributes to the overall decrease in energy transmission. When its transmission is limited, it allows non-transparent elements present in the glazing unit to be at least partially masked from the sight of passengers.

The color in transmission and reflection is also important in the choice of the sheets of glass and interlayers.

In roofs according to the invention that comprise means for controllably varying transmission, the absorption by the glass sheets, and optionally by the interlayers, may be very low. The absorption by the glass sheets, and optionally by the interlayers, mainly allows, as indicated above, transmission when the SPD film is in the clear state to be modulated.

The intrinsic absorption due to the glass sheets and to the interlayers may be significant. It is preferably at least 20% and may be as high as 40% or more. The absorption in question is the absorption whether the device is in its clear or dark state. In the clear state the device contributes to decreasing the transmission of energy and light, and possibly participates in the masking of elements contained in the glazing unit.

Generally, regarding production of the roofs according to the invention, it is recommended to bear in mind the capacity of the constituent elements to withstand the processing used to shape and assemble the glazing unit. The roofs of vehicles generally have curvatures that are relatively unaccentuated except possibly those of the edges of these glazing units. The shaping of mineral glass sheets comprises, at least for one of them and most often for both, processing that requires exposure to a high temperature (650-700° C.) that causes the glass to soften.

One alternative consists in forming a laminated glazing unit by associating a relatively thick curved sheet with a thinner planar sheet that is mechanically forced to follow closely the curvature of the thick sheet. It is envisioned to implement this technique only if the required curvatures remain relatively modest on account of the stresses that are able to be withstood, especially by the glass sheets. This type of assembly is for example such as described in patent application BE 2011/0415 (filed Jul. 4, 2011) or even in patent application BE 2012/0036 (filed Jan. 16, 2012). In the case of this type of assembly, the system of layers, even when it is relatively fragile, provided it is placed on the planar sheet, is exposed only to the temperature of the autoclave bake that concludes the assembly of the laminate.

In this assembly mode, the planar glass sheet is advantageously a chemically tempered glass sheet.

Insertion of the SPD film will preferably be facilitated by producing a lodging in the one or more interlayer sheets. This mode is described in WO 2005/102688.

Placing a glazed roof on a vehicle targets, in part at least, an objective that is equally aesthetic in nature as functional. For this reason, it is preferable for all the means associated with these roofs to contribute to the achievement of this objective.

The SPD may be controlled by simple switches. If it is desired to place a switch on the glazed roof itself, it is desirable for it not to obstruct the transparency, the reason for the choice of glazed roofs.

The invention proposes to use means for controlling the SPD that are also essentially transparent. For this purpose, the invention proposes to use switches the operation of which is triggered by way of relays actuated by a pulse associated with an electrical quantity. Preferably the switch used is a capacitive switch. This modes allows the actual structure of the elements included in the roof to be optimized.

By way of indication, the capacitive sensor may be a direct contact sensor. The sensitive element is for example a zone defined in the low-E layer located on the face turned toward the passenger compartment. Since the low-E layers are conductive, they may be used as a sensor to control the switch relay. The advantage of a direct contact sensor is that the capacitance variation induced by the contact may be relatively large so that the threshold at which the switch switches may be set high enough to prevent any risk of parasitic triggering.

It is especially recommended when setting the sensitivity level to ensure that the threshold at which the switch triggers is higher than that which corresponds, for example, to the presence of water on the exterior glass sheet. An interposed layer allows parasitic effects to be prevented. The electrodes of the SPD film in fact form a screen against influences originating from the exterior.

The invention is described in detail with reference to examples that are illustrated by the mosaics, in which:

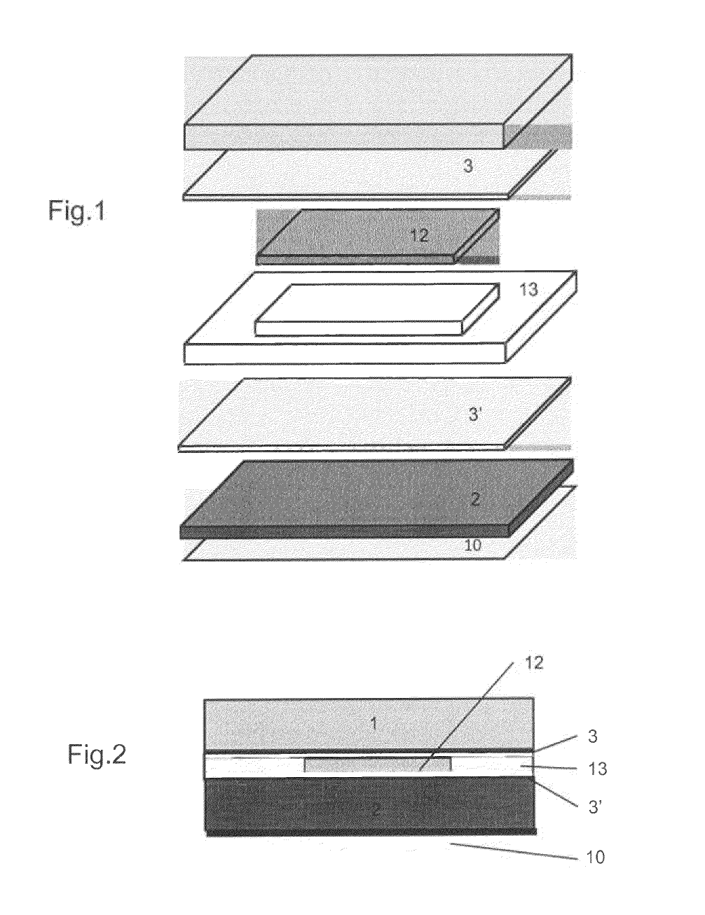

FIG. 1 shows an exploded perspective view of the elements of a glazing unit according to the invention;

FIG. 2 schematically shows the elements in FIG. 1 after assembly;

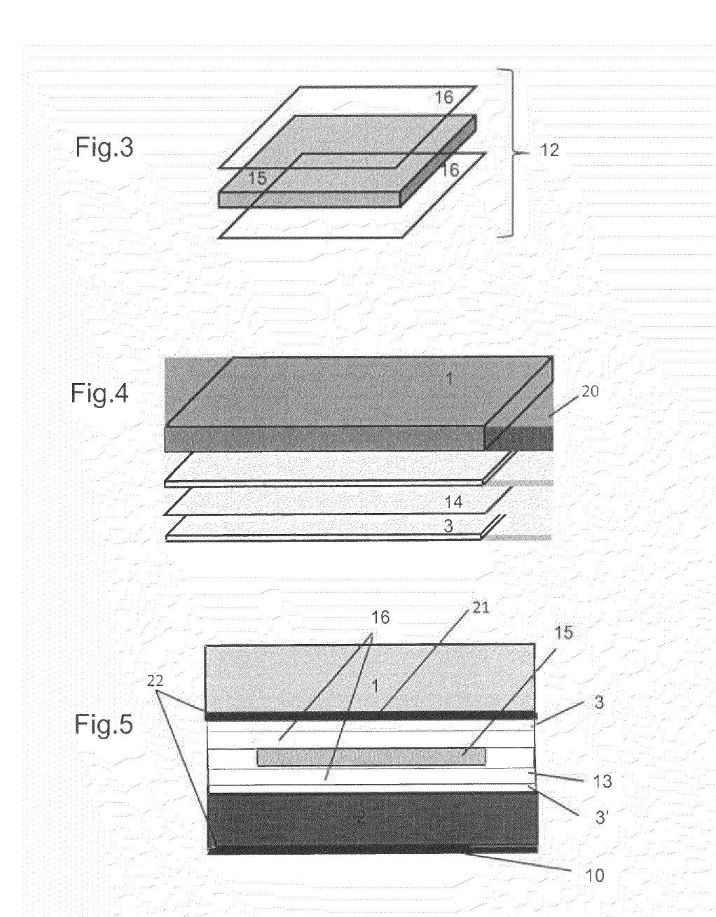

FIG. 3 shows a detail of the SPD film in FIG. 1;

FIG. 4 schematically shows elements for protecting an SPD assembly; and

FIG. 5 schematically shows, completed, the assembly in FIG. 2.

The assembly of elements in FIG. 1 is one embodiment according to the invention. The elements are shown such as they are before they are assembled. FIG. 2 shows in cross section the structure corresponding to the elements in FIG. 1 after they have been assembled.

The sheets shown in FIG. 1 are not curved, for the sake of clarity. In practice roofs, whether glazed or not, have curvatures that are ordinarily more accentuated at their edges in the place where they join with the body for a fit, chosen for its “design”, aerodynamics and its “flush” appearance, corresponding to a good surface continuity between the contiguous elements.

The glazing unit in FIG. 1 comprises two glass sheets, an external glass sheet 1 and an internal glass sheet 2. Most frequently, these two glass sheets are made of highly absorbent colored glass, such that the light transmission is limited only by the effect of these two glass sheets, for example to less than 50%, and in a configuration of this type preferably to less than 30%.

The glasses used for these sheets are for example gray glasses such as described in patent FR 2 738 238 or in patent EP 1680 371, or the green-tinted gray glasses such as described in EP 887 320, or the blue-tinted glasses described as in EP 1 140 718.

In one example, the glass sheets 1 and 2 are 1.6 mm and 2.6 mm in thickness, respectively. The sheet 1 is made of a green glass the optical properties of which are, for a thickness of 4 mm and under illuminant A:

### TL A4 27.3%; TE4 14.8%; λ_{D} 486 nm; and P 18,

(where λ_{D} is the dominant wavelength and P is the excitation purity).
The sheet 2 is made of gray glass the properties of which are:

### TL A4 17%; TE4 15%; λ_{D} 490 nm; and P 1.8.

In FIG. 1, the glass sheets are shown without the enamel patterns that are conventionally used to mask the edges of glazing units. Enamels of this type could for example be placed on the internal face of sheet 1, therefore in position 2, concealing all of the adhesive joints and localized connections at the edge of the glazing unit. The masking enamels may also be located in position 4, in other words on that face of the glazing unit which is exposed to the interior of the passenger compartment. However, in this position, for an observation from the exterior of the vehicle, they do not mask elements contained in the laminate. It is also possible to place the masks in position 2 and in position 4 as illustrated in FIG. 5.

Thermoplastic interlayer sheets (3, 3′ and 13) are placed between the glass sheets in order to join the laminate together.

The SPD film 12 is schematically shown. It does not cover the glazing unit in its entirety. The edges of the SPD film must not make contact with the exterior atmosphere, in particular in order to protect the active particles from moisture. To prevent any contact with the atmosphere, the SPD film 12 is entirely enveloped in the various interlayer sheets. To envelop the film 12 at its periphery, the interlayer sheet 13, which is of similar thickness to the SPD film, advantageously contains a suitable cut-out in which the film is lodged.

FIG. 1 shows a sheet 13 of integral construction in which a hole has been produced. It is possible to replace this integral sheet with a set of juxtaposed bands encircling the film 12, these parts fusing during the bake.

The presence of the sheet 13 isolates the SPD film and simultaneously ensures the pressure exerted on the constituents of the glazing unit during its assembly is uniformly distributed. The sheet 13 may or may not be of the same nature as the interlayers 3 and 3′.

In one embodiment, the sheets are made of PVB and each is 0.38 mm in thickness.

The structure of the SPD-type films described in patent application WO 2005/102688 is schematically shown in FIG. 3 This structure comprises a central element 15 consisting of a polymer containing orientable particles sensitive to the application of an electric voltage. On either side of this central element 15, and extending over each of the faces of the latter, two electrodes 16 allow the voltage required to control the element 15 to be applied. As known, the electrodes 16 advantageously consist of essentially transparent sheets coated with thin conductive layers. They most often consist of sheets of polyethylene glycol terephthalate (PET) of a few tens of microns in thickness, which combine a good transparency with a high mechanical resistance. On these sheets, the conductive layers are advantageously TCO (thin conductive oxide) layers such as layers of ITO (indium tin oxide).

Again in one example, the SPD film is an LCF-1103HDA film sold by Hitachi. The film has a total thickness, including the two electrodes, of 0.35 mm.

As indicated above, the components of SPD films, and especially the particles, which are organic in nature, are sensitive to aging, especially under the effect of heat. To give them the desired longevity, the film is normally protected by filters interposed between the external glass sheet 1 exposed to solar radiation and the SPD film 15.

Infrared filters are used in many applications, in solar-control glazing units or in low-E glazing units. They generally consist of thin conductive oxide layers, or better still as they perform much better, metal layers that are thin enough to be practically transparent. In these filters, the metal layers are associated with dielectric layers that are also thin and transparent, which provide the assembly with the required selectivity. Most often, in order to improve this selectivity, which is accompanied by reflection that should be made as neutral as possible, the filters comprise a plurality of metal layers which most often are based on silver.

The layers filtering the infrared are either applied to the external glass sheet or inserted by way of a polymer, especially PET, interlayer sheet. FIG. 4 shows a detail of an assembly of this type in which, under the external glass sheet 1, a sheet 14 bearing the infrared filter is placed between two interlayer sheets 3 and 20. Insofar as the PET carrier of the layers is not itself of a nature to adhere to the glass, it is necessary to insert it between two thermoplastic interlayer sheets. The use of a carrier film makes it possible not to subject the fragile layers to high temperatures. In this case, the only constraint remains the temperature of the autoclave bake of the assembly process. The downside is that an interlayer sheet must be added, thereby increasing the thickness of the assembly.

According to the invention, it is preferred to employ a system of layers deposited directly on the external glass sheet. However, as indicated, if very high-performance filters are chosen, such as those comprising metal layers, these layers are applied by cathode sputtering techniques, which are carried out on planar sheets. Thus, this solution requires these layers to undergo heat treatments when this glass sheet is shaped.

The system of layers chosen is advantageously a system that contains a number of silver layers, in order to obtain an effective filter, and that allows color, especially in reflection, to be controlled. A particularly effective assembly of layers is described in patent application WO 2011/147875. In this application, the recommended system comprises three silver layers and dielectric layers, the assembly being chosen, especially the thicknesses of the silver layers, such that the color in reflection is satisfactory even at low incidences of observation.

The assembly of components in FIG. 1 also comprises a system 10 of low-E layers, which is applied to the internal glass sheet 2 on the face turned toward the passenger compartment. This system is detached in FIG. 1 for the sake of clarity but is in fact not dissociable from the sheet under which it is deposited.

One example low-E system having the desired properties consists of a 470 nm-thick layer of tin oxide doped with 2 at % fluorine. This layer is deposited on a layer making contact with the glass, said layer being 75 nm-thick and composed of silicon oxycarbide. The two layers are deposited by CVD. On a 4 mm-thick clear glass sheet, this system leads to an emissivity of about 0.1.

Other systems of low-E layers may be produced using a cathode sputtering technique while preserving a satisfactory mechanical resistance. Systems of this type are for example composed of oxides, especially layers based on titanium oxide in association with other metal oxides, especially zirconium oxide. Layers of this type are in particular described in patent application WO 2010/031808.

By way of yet another example, a usable system comprises a layer of an alloy of chromium and zirconium. To protect this metal layer deposited by cathode sputtering, it is sandwiched between two layers of silicon nitride. This assembly also leads to a satisfactory emissivity with a decrease in the light transmission that may reach 10%, decrease that for the use in question does not constitute a drawback.

The use of these low-E systems considerably improves how comfortable the passenger compartment feels during cold periods and may make the use of a screen superfluous.

FIG. 5 schematically shows a glazing unit according to the invention after its various constituents have been assembled. This figure is not to scale. In particular, the thickness of the SPD film and of the films bearing the conductive elements has been very much exaggerated.

In FIG. 5, a system of layers filtering the infrared is shown referenced 21. This system is applied directly to the glass sheet 1 on face 2. Analogously, a low-E system 10 is applied to the glass sheet 2 on face 4.

Enamel bands 22 are shown on the edges of the glazing unit. These enamel bands are applied by screen-printing techniques to the glass sheets after they have been covered with the layers. The enamel bands are arranged, in FIG. 4, such that they cover the limits of the SPD film 15. They conceal these limits both from the exterior and from the interior of the vehicle. They also serve to mask the electrical connections (not shown) that supply power to the electrodes of the SPD film.

1. A laminated and glazed automotive vehicle roof having variable light transmission and offering improved thermal comfort, comprising two glass sheets, an external glass sheet and an internal glass sheet, that are joined by means of thermoplastic interlayer sheets, an assembly, of the SPD (suspended particle device) film type, for regulating light transmission, which is incorporated into the laminate between the two glass sheets, and a system of low-emissivity layers placed on face 4 of the glazing unit.

2. The roof as claimed in claim 1, in which the system of low-emissivity layers has an emissivity that is no higher than 0.3 and preferably no higher than 0.2 and in a particularly preferred way no higher than 0.1.

3. The roof as claimed in claim 1, in which the system of low-emissivity layers comprises at least one layer of doped tin oxide.

4. The roof as claimed in claim 3, in which the layer of tin oxide is doped with fluorine and has a thickness that is no smaller than 200 nm.

5. The roof as claimed in claim 3, in which the system of low-emissivity layers comprises, under the layer of tin oxide, a layer based on silica or silicon oxycarbide.

6. The roof as claimed in claim 5, in which the layer of silicon oxycarbide has a thickness such that it minimizes reflection of wavelengths in the visible.

7. The roof as claimed in claim 1, comprising a system of layers selectively reflecting the infrared, said system being placed between the external glass and the SPD film.

8. The roof as claimed in claim 7, in which the infrared filter consists of an assembly of thin silver-based layers and dielectric layers to improve selectivity.

9. The roof as claimed in claim 8, in which the system of layers comprises at least three silver layers separated from one another by dielectric layers.

10. The roof as claimed in claim 1, in which the system of layers selectively reflecting the infrared is applied to the external glass sheet, on face 2.

11. The roof as claimed in claim 1, in which the components are chosen so that visible light reflection toward the exterior, irrespectively of whether the SPD is in its clear or dark state, does not exceed 20% and, preferably, does not exceed 15% of the incident light.

12. The roof as claimed in claim 1, in which the components are chosen such that the energy transmission when the SPD is in its dark state is no higher than 10% and preferably no higher than 5%.

13. The roof as claimed in claim 1, in which the energy transmission in the clear state is no higher than 20% and preferably no higher than 15%.

14. The roof as claimed in claim 1, in which the components are chosen such that, in the dark state, the light transmission is no higher than 3%, preferably no higher than 2% and in a particularly preferred way no higher than 1%.

15. The roof as claimed in claim 1, in which the components are chosen such that, in the clear state, the light transmission is no higher than 50% and preferably lower than 40%.

16. The roof as claimed in claim 1, in which the glass sheets and interlayers together have an absorption of at least 20%.

17. The roof as claimed in claim 1, in which the components are chosen such that, irrespectively of whether the SPD is in its clear or dark state, the color in reflection, defined by CIE Lab color coordinates, is comprised in the intervals:
−8<a*<3
−7<b*<3
and preferably
−7<a*<3
−2<b*<1.
